(19) United States
(12) Patent Application Publication
(10) Pub. No.: US 2016/0370910 A1
(43) Pub. Date: Dec. 22, 2016

(54) ELECTRONIC DEVICE INCLUDING A TOUCH PAD

(71) Applicant: SAMSUNG ELECTRONICS CO., LTD., Suwon-si (KR)

(72) Inventors: Byung-Ku PARK, Anyang-si (KR); Seung-Min BAE, Hwaseong-si (KR); Do-Kyun LEE, Seoul (KR)

(21) Appl. No.: 15/161,819

(22) Filed: May 23, 2016

(30) Foreign Application Priority Data
Jun. 19, 2015 (KR) 10-2015-0087810

(51) Int. Cl. G06F 3/041

(52) U.S. Cl. CPC G06F 3/0414

(57) ABSTRACT

An electronic device including a touch pad is disclosed, and may include: a body; a touch pad coupled to the body; a dome switch disposed on a rear surface of the touch pad; and a pressure sensor disposed to be in contact with the dome switch. The pressure sensor may detect a pressure applied to the touch pad.

### CROSS-REFERENCE TO RELATED APPLICATION

This application is based on and claims priority under 35 U.S.C. §119 to Korean Application Serial No. 10-2015-0087810, which was filed in the Korean Intellectual Property Office on Jun. 19, 2015, the disclosure of which is incorporated by reference herein in its entirety.

### TECHNICAL FIELD

The disclosure relates to an electronic device, for example, an electronic device that includes an input device.

### BACKGROUND

An electronic device refers to a device that performs a specific function according to a program incorporated therein, such as a desktop/laptop computer, a tablet PC, an electronic scheduler, a portable multimedia reproducer, a mobile communication terminal, a video/sound device, and a vehicle navigation system, including a home appliance. For example, the above-mentioned electronic devices may output information stored therein, in the form of a sound or an image. In addition, portable electronic devices, for example, a laptop computer, a tablet PC, an electronic scheduler, a portable multimedia reproducer, and a mobile communication terminal, generally include a display device and a battery.

There are various kinds of input devices for these electronic devices. For example, the desktop computer includes an input device, such as a keyboard or a mouse, and a home appliance may be provided with a remote controller. In the electronic devices, such as the mobile communication terminal, a microphone and a keypad have been utilized as traditional input devices, and in the laptop computer, a touch pad replacing the mouse has been used as the input device.

The touch pad is implemented in a conventional capacitive type so that the touch pad is capable of detecting a touch of a user's body part, for example, a finger.

### SUMMARY

A touch pad used for inputting information to an electronic device may deliver feedback in response to the user's touch using, for example, haptics. However, when haptics are applied to a touch pad, the configuration of the touch pad may become complicated, which may cause deterioration in touch sensitivity.

Therefore, various examples of the disclosure describe an electronic device that provides a physical click feeling in order to deliver feedback in response to the user's touch to a touch pad.

In addition, various examples of the disclosure provide an electronic device that detects not only a positional coordinate based on the user's touch but also a first pressure value so as to receive further subdivided input signals based on the first pressure value.

According to various examples, an electronic device may include a body; a touch pad coupled to the body; a dome switch disposed on a rear surface of the touch pad; and a pressure sensor in contact with the dome switch. The pressure sensor may detect a pressure applied to the touch pad.

According to various examples of the disclosure, since the dome switch is provided on one surface of the touch pad, the electronic device can provide a physical click feeling in response to a user's touch. In addition, since the pressure sensor detects a compressed level of the dome switch, further subdivided input information may be provided by detecting a first pressure value based on the user's touch.

### BRIEF DESCRIPTION OF THE DRAWINGS

The above and other aspects, features, and advantages of the disclosure will become more apparent from the following detailed description, taken in conjunction with the accompanying drawings, in which like reference numerals refer to like elements, and wherein:

FIG. 1 is a perspective view illustrating an example electronic device;

FIG. 2 is a sectional view illustrating an example touch pad and an example dome switch of a conventional electronic device;

FIG. 3 is a sectional view illustrating an example touch pad and an example pressure sensor of another conventional electronic device;

FIG. 4 is a sectional view illustrating an example touch pad, dome switch, and pressure sensor of an example electronic device;

FIG. 5 is a rear view illustrating the inside of an example electronic device;

FIG. 6 is a sectional view illustrating an example hinge unit of an electronic device;

FIG. 7 is a view illustrating the inside of an example electronic device;

FIG. 8 is a rear view illustrating the inside of the electronic device illustrated in FIG. 7;

FIG. 9 is a sectional view taken along line A-A′ in FIG. 8;

FIG. 10 is a sectional view taken along line B-B′ in FIG. 8;

FIG. 11 is a flowchart illustrating an example input method of an example electronic device;

FIG. 12 is a front view illustrating an example situation in which a user clicks on a touch pad of an electronic device;

FIG. 13 is a graph illustrating an example pressure value detected by the pressure sensor of the electronic device;

FIG. 14 is a graph obtained by converting the pressure value of the graph illustrated in FIG. 13;

FIG. 15 is a flowchart illustrating an example input method of an electronic device;

FIG. 16 is a front view illustrating an example touch pad of the electronic device;

FIG. 17 is a perspective view illustrating an example touch pad and a display window of the electronic device;

FIG. 18 is the front view illustrating an example touch pad of the electronic device;

FIG. 19 is a perspective view illustrating an example touch pad and a display window of the electronic device;

FIG. 20 is a sectional view illustrating an example touch pad and a ground of an electronic device;

FIG. 21 is a graph illustrating an example change in capacitance in a case where the touch pad of the electronic device is compressed with a first pressure;

FIG. 22 is a graph illustrating an example change in capacitance in a case where the touch pad of the electronic device is compressed with a second pressure; and

FIG. 23 is a front view illustrating an example ground of an electronic device.

### DETAILED DESCRIPTION

Hereinafter, various examples of the disclosure will be described with reference to the accompanying drawings. However, it should be understood that there is no intent to limit the disclosure to the particular examples disclosed herein; rather, the disclosure should be construed to cover various modifications, equivalents, and/or alternatives of examples of the disclosure. In describing the drawings, similar reference numerals may be used to designate similar constituent elements.

In the disclosure, the expression “have”, “may have”, “include” or “may include” refers to existence of a corresponding feature (e.g., numerical value, function, operation, or components such as elements), and does not exclude existence of additional features.

In the disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various examples of the disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposed between them. It may also be understood that when an element (e.g., first element) is referred to as being “directly connected,” or “directly coupled” to another element (second element), there are no element (e.g., third element) interposed between them.

The terms used herein are merely for the purpose of describing particular examples and are not intended to limit the scope of other examples. As used herein, singular forms may include plural forms as well unless the context clearly indicates otherwise. Unless defined otherwise, all terms used herein, including technical terms and scientific terms, may have the same meaning as commonly understood by a person of ordinary skill in the art to which the disclosure pertains. Such terms as those defined in a generally used dictionary may be interpreted to have the meanings along the lines of the contextual meanings in the relevant field of art, and are not to be interpreted to have ideal or excessively formal meanings unless clearly defined in the disclosure. In some cases, even a term defined in the disclosure should not be interpreted to exclude examples of the disclosure.

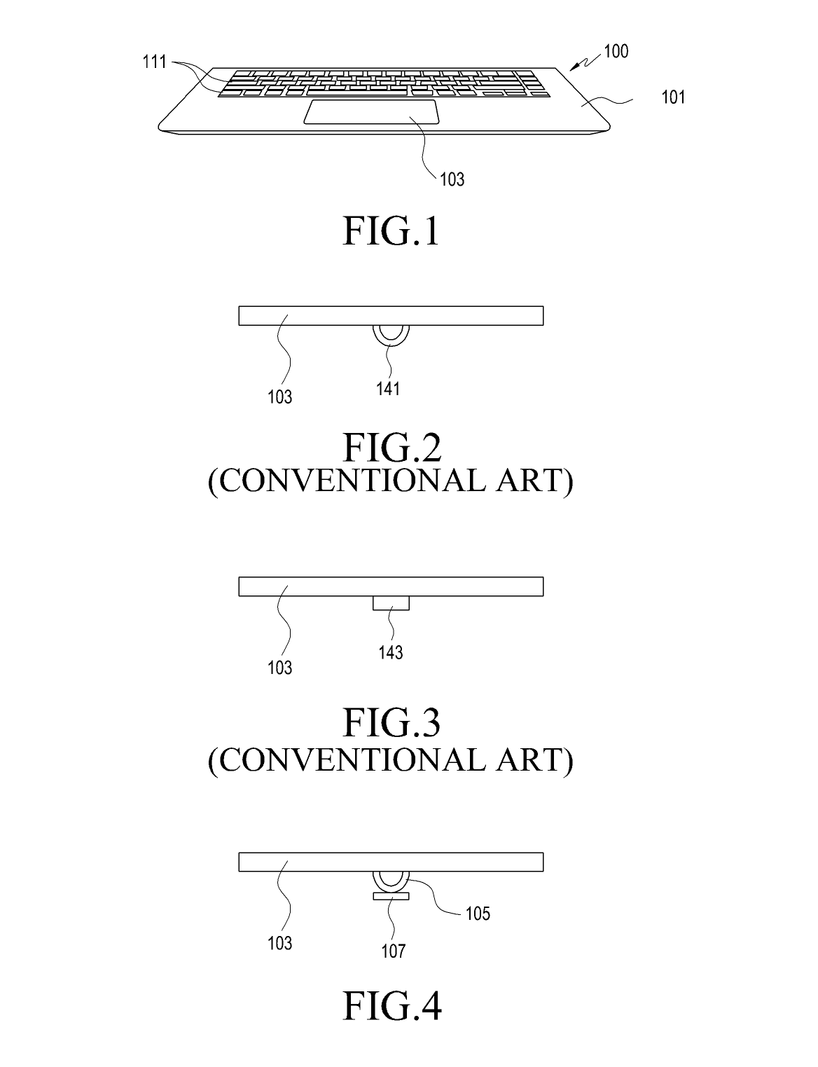

FIG. 1 is a perspective view illustrating an example electronic device.

According to various examples of the disclosure, the electronic device may be, for example, a laptop computer, a tablet PC, a terminal, a portable communication terminal, or a keyboard, etc. The electronic device may communicate with an external electronic device, such as a server or the like, or perform an operation through an interworking with the external electronic device. For example, the electronic device may transmit an image photographed by a camera and/or position information detected by a sensor unit to the server through a network. The network may be a mobile or cellular communication network, a Local Area Network (LAN), a Wireless Local Area Network (WLAN), a Wide Area Network (WAN), an Internet, a Small Area Network (SAN) or the like, but is not limited thereto. The electronic device according to the present example will be described with reference to a laptop computer as an example.

Referring to FIG. 1, according to various examples of the disclosure, the electronic device 100 may include a body 101, a keyboard 111, and a touch pad 103.

The body 101 may be equipped with, for example, a main board, a Central Processing Unit (CPU) mounted on the main board, a storage medium, and a battery connected to the main board so as to supply power.

The keyboard 111 may be mounted on the front surface of the body 101 so as to generate an input signal by a user's click.

The touch pad 103 may be mounted on the front surface of the body 101 and disposed close to the keyboard 111. In addition, the front surface of the touch pad 103 may be laid on the same plane as the front surface of the body 101. The touch pad 103 may be implemented as a capacitive type so as to generate an input signal by a touch of the user's body part, for example, a finger.

In addition, according to various examples of the disclosure, the electronic device 100 may include a display device (not shown) that outputs an image or a video image. In the example case of a laptop computer, the display device may be pivotally connected with the body 101 and may conceal the front surfaces of the keyboard 111 and the touch pad 103.

FIG. 2 is a sectional view illustrating a touch pad and a dome switch of a conventional electronic device.

Referring to FIG. 2, the conventional electronic device may include a touch pad 103 and a dome switch 141 so that the dome switch 141 may be compressed by the pressure applied to the touch pad 103.

The dome switch 141 is disposed on the rear surface of the touch pad 103, and pushed by the pressure applied to the touch pad 103 so as to provide a click feeling to a user. In addition, the dome switch 141 may perform an input function by generating an ON/OFF input signal depending on whether it is compressed or not.

However, such a conventional electronic device merely senses the touch position touched on the touch pad 103, but is limited in subdividing an input signal based on the user's clicking pressure.

FIG. 3 is a sectional view illustrating a touch pad and a pressure sensor of another conventional electronic device.

Referring to FIG. 3, the other conventional electronic device may include a touch pad 103 and a pressure sensor 143 so that a pressure applied to the touch pad 103 may be detected by the pressure sensor 143.

In addition, a plurality of pressure sensors 143 may be disposed on the rear surface of the touch pad 103 in order to more precisely detect a pressure applied to each point on the front surface of the touch pad 103.

The other conventional electronic device may utilize the pressure applied to the touch pad 103 as a further subdivided signal using the plurality of pressure sensors 143. However, since a plurality of pressure sensors 143 are needed, the manufacturing cost may increase. In addition, another electronic device may deliver a click feeling to the user as feedback using haptics through, for example, a vibration element or a speaker. However, such feedback may be different from the click feeling obtained when the user physically pushes, for example, a button on a keyboard.

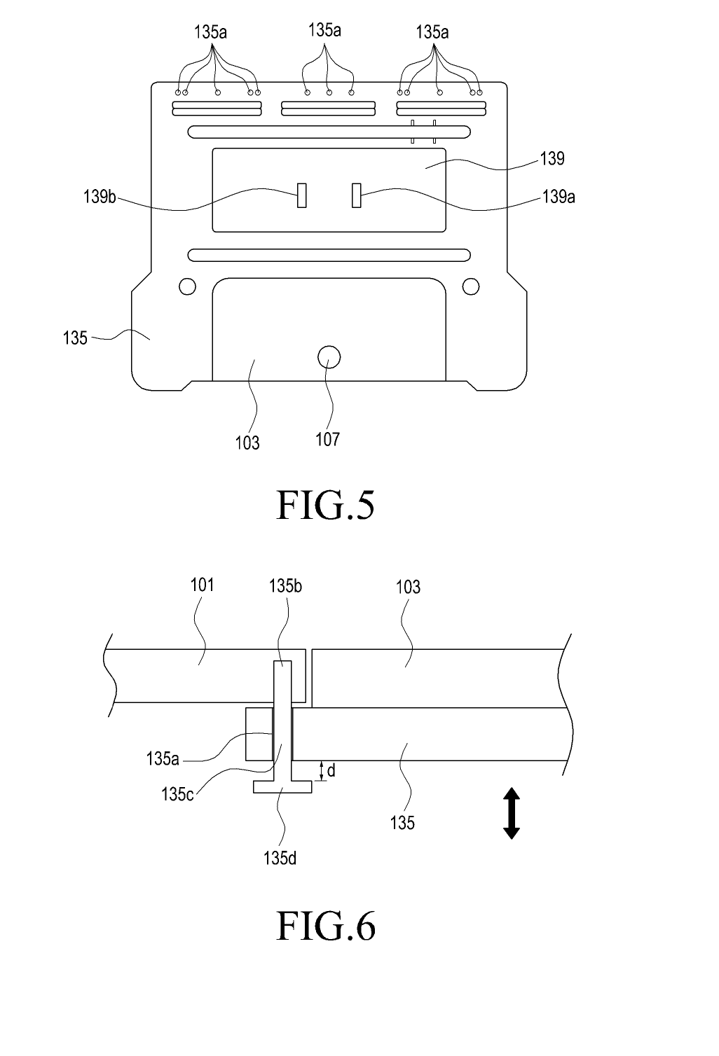

FIG. 4 is a sectional view illustrating an example touch pad, dome switch, and pressure sensor of an example electronic device. FIG. 5 is a rear view illustrating the inside of an example electronic device.

Referring to FIGS. 4 and 5, according to an example of the disclosure, an electronic device may include a touch pad 103, a dome switch 105, and a pressure sensor 107 arranged so that when a user touches or clicks the touch pad 103, a touch position on the touch pad 103 and a first pressure value can be detected.

The touch pad 103 may include a bracket 135 attached to the rear surface of the touch pad 103, and the bracket 135 may be pivotally coupled to the body 101 (FIG. 1).

The dome switch 105 may be disposed on the rear surface of the touch pad 103 to be pushed by the pressure applied to the touch pad 103 by the user's touch.

Since the pressure sensor 107 may be in contact with the dome switch 105, the pressure applied to the touch pad 103 may be delivered to the pressure sensor 107 via the dome switch 105. As a result, the pressure sensor 107 may detect the pressure applied to the touch pad 103.

According to one of various examples of the disclosure, since the electronic device includes the dome switch 105 pushed by the pressure applied to the touch pad 103 by the user as described above, a click feeling can be provided to the user. In addition, since the electronic device includes the pressure sensor 107 that detects the first pressure value applied to the touch pad 103 by the user, input signals subdivided based on various pressure values can be generated.

In addition, a circuit board 139 may, for example, be provided on the rear surface of the touch pad 103 so that integrated circuit chips 139a and 139b may be mounted on the circuit board 139. The integrated circuit chips may include a first integrated circuit chip 139a that processes a touch position on the touch pad 103 which is determined by the user's touch on the touch pad 103, and a second integrated circuit chip 139b that processes a first pressure value applied to the touch pad 103. However, the disclosure is not limited by the separation of the first integrated circuit chip 139a and the second integrated circuit chip 139b, and the touch position and the first pressure value may be processed by a single integrated circuit chip.

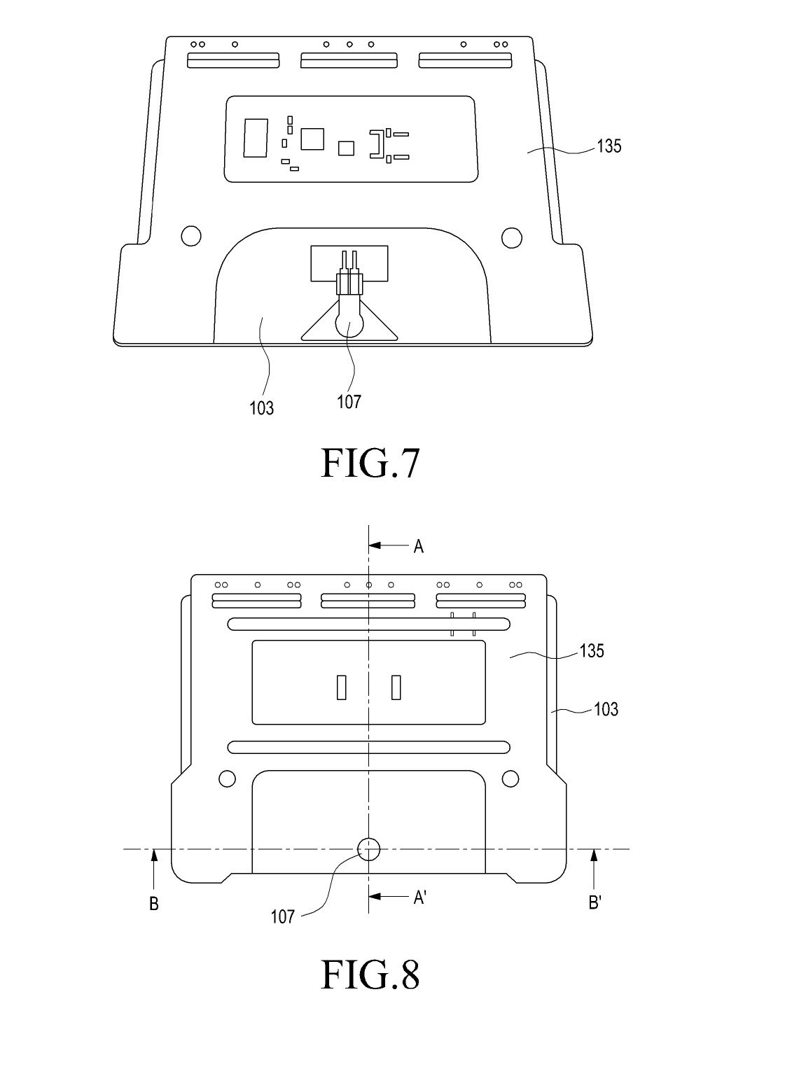

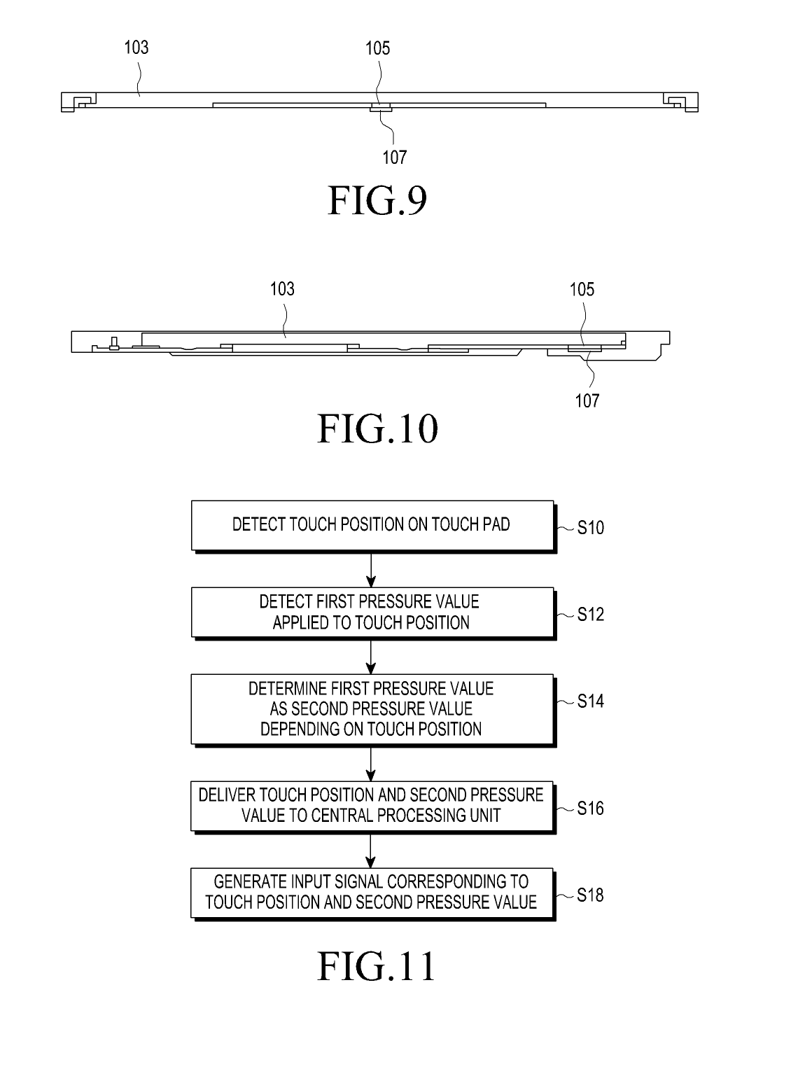

FIG. 6 is a sectional view illustrating an example hinge unit of an example electronic device. FIG. 7 is a view illustrating the inside of an example electronic device. FIG. 8 is a rear view illustrating the inside of the electronic device illustrated in FIG. 7. FIG. 9 is a sectional view taken along line A-A′ in FIG. 8. FIG. 10 is a sectional view taken along line B-B′ in FIG. 8.

Referring to FIGS. 6 to 10, according to another example of the disclosure, the electronic device may include hinge units 135b, 135c that interconnect one end of the body 101 (FIG. 1) and one end of the touch pad 103 to be pivotable in relation to each other.

Each of the hinge unit 135b, 135c may include a first hinge portion 135b coupled and fixed to the body 101 (FIG. 1), a second hinge portion 135c extending from the first hinge portion 135b and inserted into one of holes 135a formed in the bracket 135, and a third hinge portion extending from the second hinge portion 135c and having an outer diameter larger than the inner diameter of the holes 135a.

In a state where the first hinge portion 135b is fixed to the body 101 (FIG. 1), the rear surface of the bracket 135 may be spaced apart from the third hinge portion 135d by a gap d. When the user applies a pressure to the touch pad 103, the bracket 135 may perform a reciprocating movement along the longitudinal direction of the second hinge portion 135c through the corresponding hole 135a, and the reciprocating movement of the bracket 135 may be performed within the gap d. Since the outer diameter of the second hinge portion 135c may be smaller than the inner diameter of the holes 135a, the bracket 135 may perform the reciprocating movement within the gap in a direction inclined to the longitudinal direction of the second hinge portion 135c. As a result, the other end of the touch pad 103 coupled to the bracket 135 may be moved by the pressure applied to the touch pad 103.

In addition, the pressure sensor 107 may be disposed close to the other end of the touch pad 103. As the other end of the touch pad 103 is moved by the pressure applied to the touch pad 103, the pressure sensor 107 may detect the first pressure value delivered thereto via the dome switch 105. Thus, the electronic device can detect the first pressure value applied to the touch pad 103 using a single pressure sensor 107.

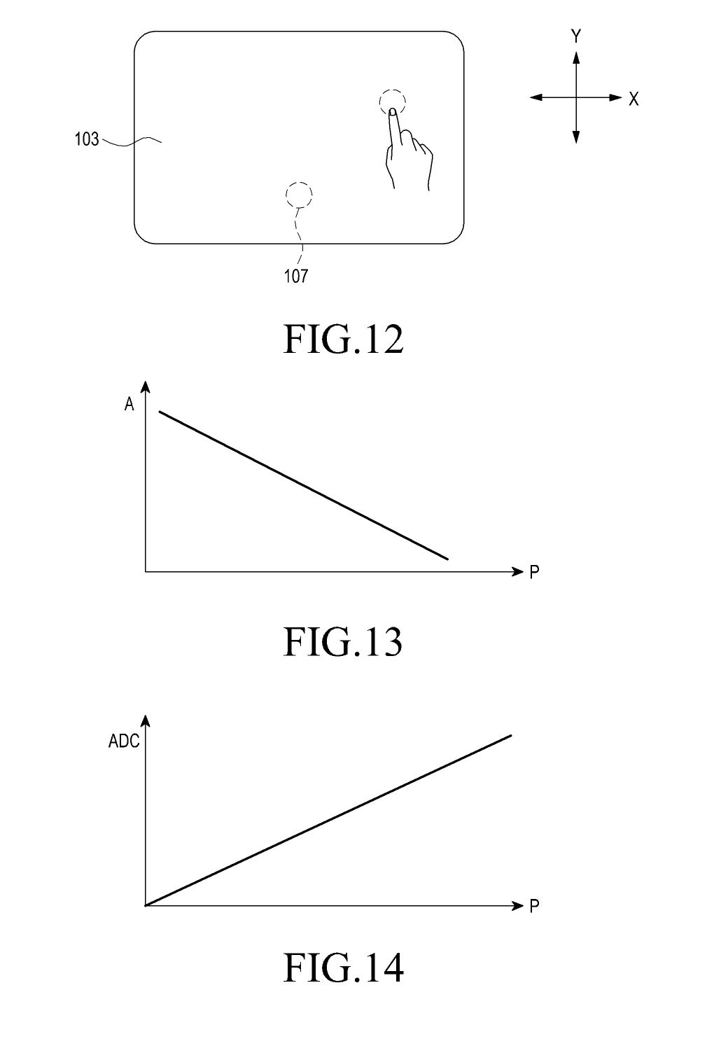

FIG. 11 is a flowchart illustrating an example input method of an electronic device. FIG. 12 is a front view illustrating an example situation in which a user clicks on an example touch pad of an electronic device. FIG. 13 is a graph illustrating an example pressure value detected by the pressure sensor of the electronic device. FIG. 14 is a graph obtained by converting the pressure value of the graph illustrated in FIG. 13.

Referring to FIGS. 11 to 14, according to an example of the disclosure, an input method of an electronic device may include: an operation of detecting a touch position on a touch pad (S10); an operation of detecting a first pressure value applied to the touch position (S12); an operation of compensating for a deviation of the first pressure value based on the touch position to determine a second pressure value (S14); delivering the touch position and second pressure value to, for example, a central processing unit (CPU) (S16); and an operation of generating an input signal from the touch position and the second pressure value determined with respect to the deviation compensation based on the touch position (S18).

When the user touches the touch pad 103, the operation of detecting the touch position on the touch pad (S10) may detect the touch position from a change in capacitance of the touch pad 103, as illustrated in FIG. 12.

As described in the above example, in the operation of detecting the first pressure value applied to the detected touch position (S12), the other end of the touch pad 103 may be moved by the pressure applied to the touch pad by the user's touch. As the other end of the touch pad 103 is moved, the pressure sensor 107 may detect the first pressure value applied to the detected touch position.

In addition, according to an example of the disclosure, the input method of the electronic device may further include an operation of converting the measured pressure value into a digital signal or value.

In the operation of converting the measured pressure value into a digital value, the pressure sensor 107 may detect the first pressure value and may deliver the first pressure value to the second integrated circuit chip 139b, and the first pressure value may be converted into a digital value by the second integrated circuit chip 139b. The pressure value A converted into digital may be inversely proportional to the pressure P applied to the touch pad, as illustrated in FIG. 13. Accordingly, the second integrated circuit chip 139b may convert the first pressure value A to be proportional to the pressure P applied to the touch pad 103 in addition to converting the first pressure value A into digital. Accordingly, the pressure value ADC finally converted by the second integrated circuit chip 139b may be proportional to the pressure P applied to the touch pad 103, as illustrated in FIG. 14.

The first pressure value detected by the pressure sensor 107 may vary depending on a pushed position even if the user pushes the touch pad 103 with the same pressure. For example, the first pressure value applied with the same pressure at the touch position on the touch pad 103 may vary depending on a distance to the pressure sensor 107.

An operation of determining the first pressure value as a second pressure value depending on the touch position (S14) may determine the first pressure value that varies depending on the touch position of the touch pad 103 as the second pressure value that is a pressure value practically pressed to the touch pad 103. The operation of determining the first pressure value as the second pressure value depending on the touch position (S14) may include an operation of determining the first pressure value detected depending on the pressure on the touch pad 103 where the pressure sensor 107 is positioned, as a reference pressure value, and an operation of determining the detected first pressure value depending on the touch position on the touch pad 103. The operation of determining the first pressure value as the second pressure value depending on the touch position (S14) may, for example, compare the first pressure value detected depending on the touch position on the touch pad 103 with the reference pressure value, and may determine the first pressure value as the second pressure value corresponding to the reference pressure value. For example, according to an example of the disclosure, the input method of the electronic device may advantageously determine the pressure value depending on each touch position on the touch pad 103 even though the electronic device includes one pressure sensor 107.

An operation of delivering the touch position and the second pressure value to a Central Processing Unit (CPU) (S16) may be performed in an integrated circuit chip provided in the touch pad 103. As described above, the CPU may be provided in the electronic device.

In addition, the operation of determining the first pressure value as the second pressure value depending on the touch position (S14) may be executed through a control unit. The control unit may be the integrated circuit chip provided in the touch pad 103. However, the control unit is not limited to the integrated circuit chip, and may be the CPU of the electronic device.

An operation of generating a input signal corresponding to the touch position and the second pressure value (S18) may be executed in the CPU. In addition, the input signal may correspond to, for example, an image output to the display device provided in the electronic device.

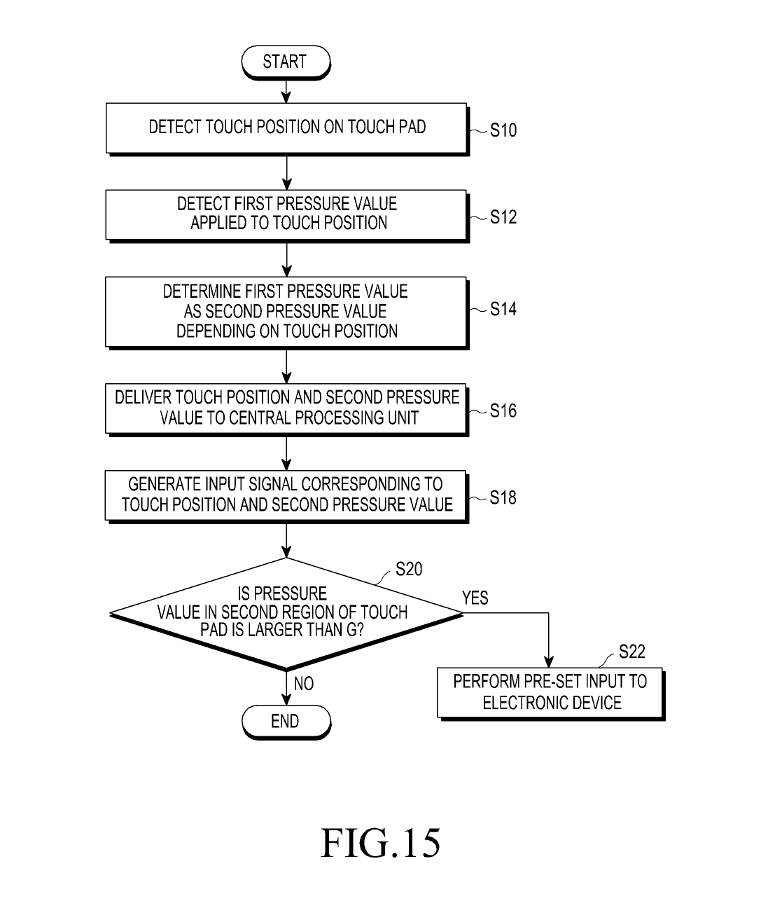

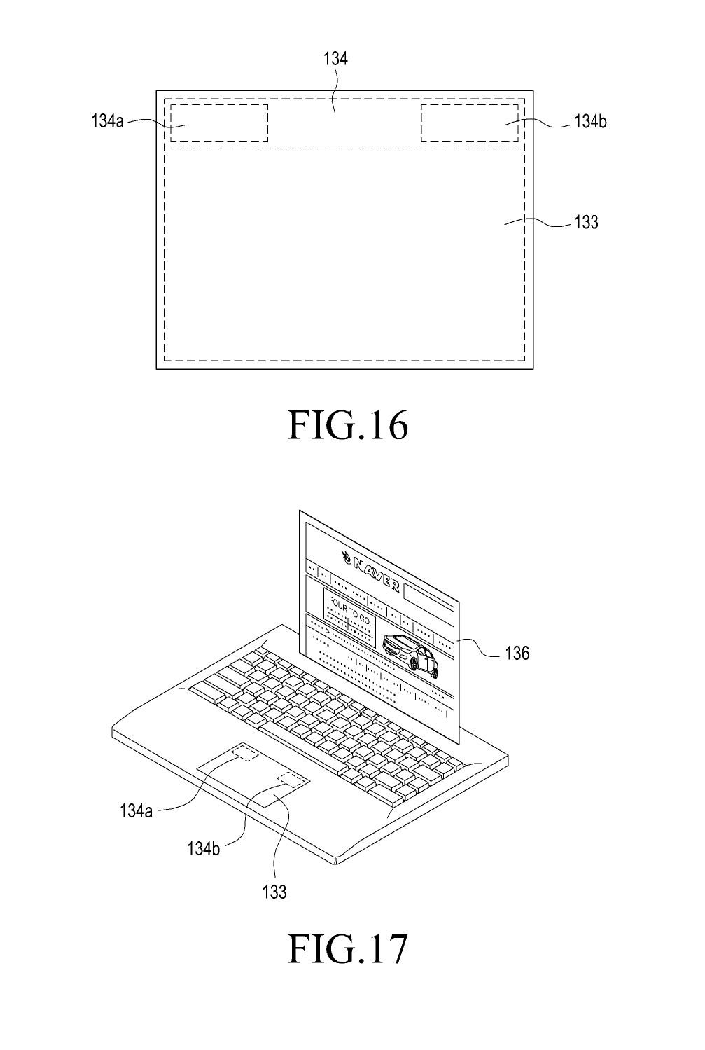

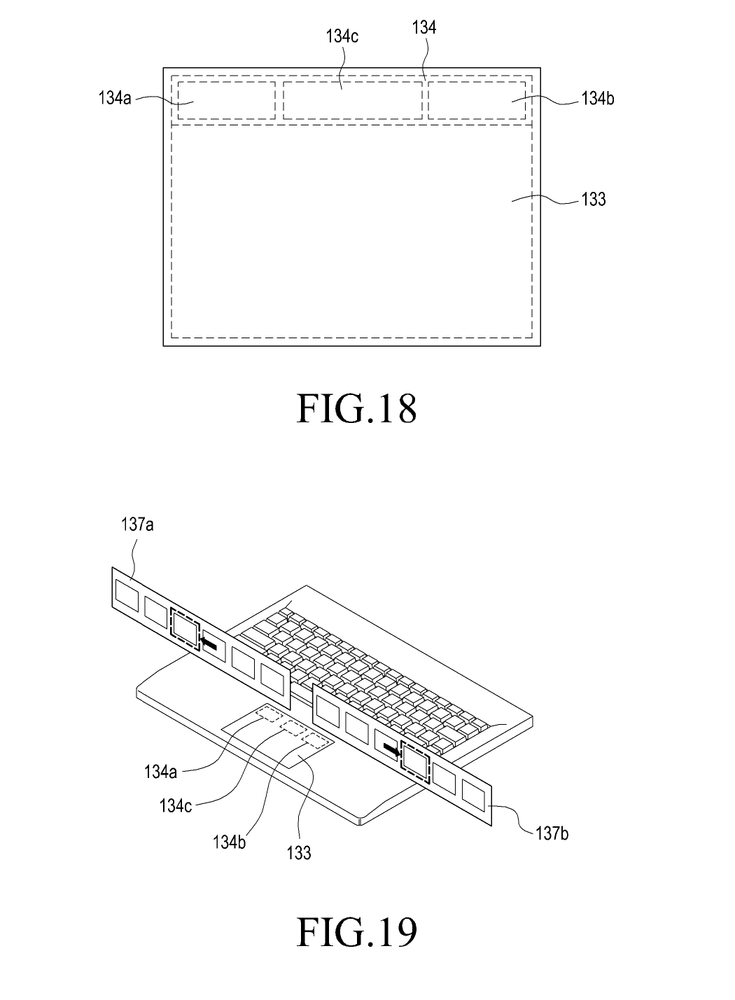

FIG. 15 is a flowchart illustrating an example input method of an electronic device. FIG. 16 is a front view illustrating an example touch pad of the electronic device. FIG. 17 is a perspective view illustrating an example touch pad and a display window of the electronic device. FIG. 18 is a front view illustrating an example touch pad of the electronic device. FIG. 19 is a perspective view illustrating an example touch pad and a display window of the electronic device.

Descriptions will be made on an electronic device according to various examples of the disclosure and an input method thereof with reference to FIGS. 15 to 19.

A touch pad of the electronic device may include a first region 133, in which the touch pad 103 (FIG. 5) pivotally coupled to the body 101 (FIG. 1) pivots, and a second region 134 adjacent to one end of the touch pad 103 (FIG. 5) pivotally coupled to the body 101 (FIG. 1). The second region 134 may be a region that is not pushed by the dome switch 105 (FIG. 4) even if the user applies a pressure to the touch pad 103 (FIG. 5). When the user performs a touch input in the second region 134, the pressure sensed by the pressure sensor 107 may have a third pressure value G With reference to FIG. 15, steps S10-S18 are similar to those described above with reference to FIG. 11. Therefore, an overlapping description is not repeated here.

In the case where a pressure is applied to the second region 134, which is a region adjacent to the portion where the touch pad 103 is pivotally connected to the electronic device, the input method of the electronic device may include an operation of comparing the second pressure value with the pre-set third value G (S20), and in the case where the measured second pressure is larger than the third pressure value G, the input method may include an operation of performing a pre-set input on the electronic device (S22).

When the user performs a touch input in any one portion 134a in the second region 134, for example, as illustrated in FIGS. 16 and 17, the operation of performing the pre-set input on the electronic device may switch a website displayed on the display window 136 of the electronic device to a previously displayed website. Here, the display window 136 may refer to a portion provided on the front surface of the display device of the electronic device so as to display an image or a video image.

In addition, when the user performs a touch input in any other portion 134b in the second region 134, the website displayed on the display device of the electronic device may, for example, be switched to another website. In addition, when the user performs a multi-touch input in any one portion 134a in the second region 134, for example, when the user performs a touch input using two fingers, a previously executed program may be executed again in the electronic device. In addition, when the user performs the multi-touch input in any other portion 134b in the second region 134, a program pre-set by the user (e.g., a calculator program) may be executed in the electronic device.

According to various examples of the disclosure, the electronic device may be a portable electronic device, such as a tablet PC. In addition, as illustrated in FIGS. 18 and 19, the second region 134 may be divided into a first portion 134a, a second portion 134b, and a third portion 134c interposed between the first portion 134a and the second portion 134b.

For example, when the user performs a touch input in the first portion 134a, the operation of performing the pre-set input on the electronic device may switch an application displayed on the display device of the electronic device to a previously displayed application. In addition, when the user performs a touch input in the second portion 134b, applications displayed on the display windows 137a and 137b of the electronic device may be switched to other applications. Here, the display windows 137a and 137b may, for example, refer to portions provided on the front surface of the display device provided in the electronic device so as to display an image or a video image.

In addition, when the user performs a touch input in the third portion 134c, a main home screen of the display window of the electronic device may, for example be displayed.

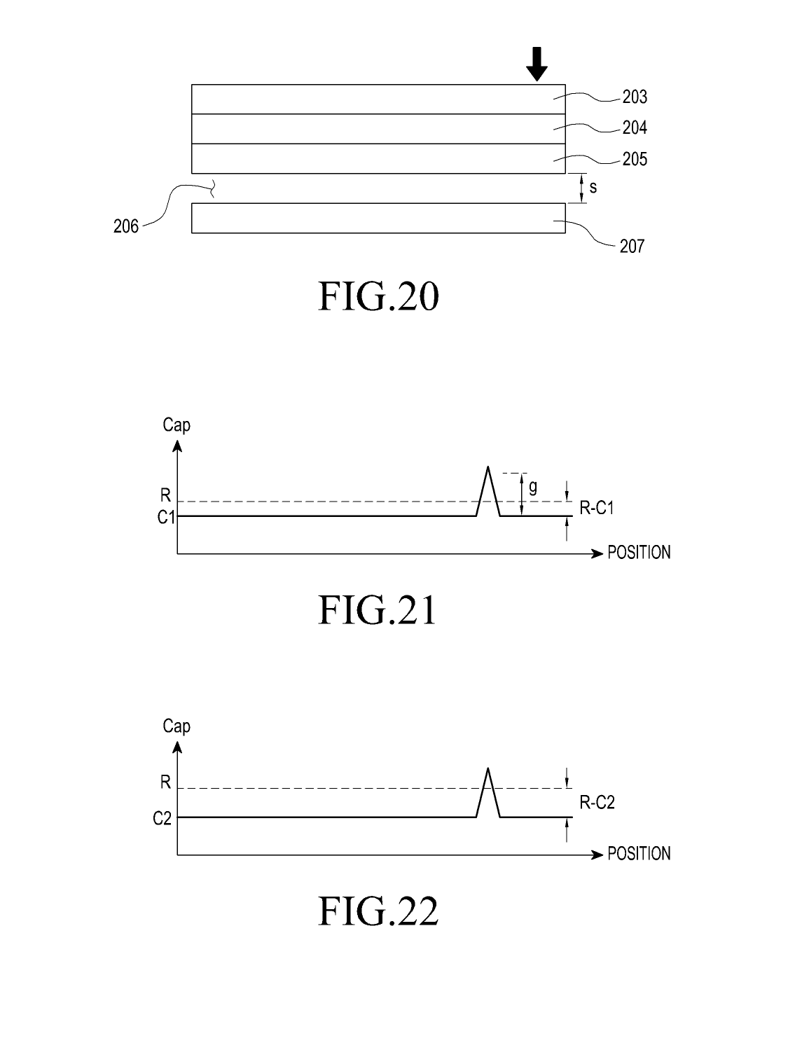

FIG. 20 is a sectional view illustrating an example touch pad and a ground of an electronic device. FIG. 21 is a graph illustrating an example change in capacitance in a case where the touch pad of the electronic device is compressed with a first pressure. FIG. 22 is a graph illustrating an example change in capacitance in a case where the touch pad of the electronic device is compressed with a second pressure.

Referring to FIGS. 20 to 22, according to various examples of the disclosure, an electronic device may include a touch pad 203, 204, 205 and a ground 207.

The touch pad may include a glass substrate 203, a first layer 204, and a second layer 205 so that when the user's body part, for example, a finger, comes close to or into contact with the glass substrate 203, the capacitance of the touch pad can be changed. The glass substrate 203 may form the outer surface of the touch pad. The first layer 204 may be disposed on one surface of the glass substrate 203 to receive an electric signal transmitted from the second layer 205 to be described later. The second layer 205 may be disposed on one surface of the first layer 204 to transmit an electric signal to the first layer 204. In addition, as the electric signal transmitted from the second layer 205 is received to the first layer 204, the touch pad 203, 204, 205 may, for example, have a reference capacitance R detected at each position on the touch pad. For example, when the user's body part or a conductive object does not come close to the touch pad, the reference capacitance R may be detected at each position on the touch pad.

The ground 207 may be disposed to face one surface of the second layer 205 and to be spaced apart from the second layer 205. The ground 207 may, for example, be spaced apart from the one surface of the second layer 205 by a gap s to form a space 206 together with the second layer 205.

When the user touches the glass substrate 203, the capacitance Cap at the touch position increases by g as illustrated in FIG. 21 so that the touch pad 203, 204, 205 may detect the touch position from the change g of the capacitance.

In addition, as the user touches the glass substrate 203, the touch pad 203, 204, 205 may be compressed so that the gap between the touch pad 203, 204, 205 and the ground 207 may be reduced. At this time, the electric signals generated from the second layer 205 may be absorbed to the ground 207, of which the relative position in relation to the second layer 205 is changed. In addition, the electric signals received to the first layer 204 are relatively reduced as the amount absorbed to the ground 207 increases so that the reference capacitance R may be changed. That is, the reference capacitance R may be reduced to a changed reference capacitance C1 as the gap between the touch pad 203, 204, 205 and the ground 207 is reduced.

Upon comparing FIGS. 21 and 22, it can be seen that the graph illustrated in FIG. 22 represents a reference capacitance C2 changed when the user's touch force increases, and the change in reference capacitance (R-C2) illustrated in FIG. 22 is larger than the change in reference capacitance (R-C1) illustrated in FIG. 21. As a result, according to various examples of the disclosure, the electronic device may utilize a pressure applied by the user's touch as an input signal of the electronic device as the touch pad 203, 204, 205 detects the change in the reference capacitance.

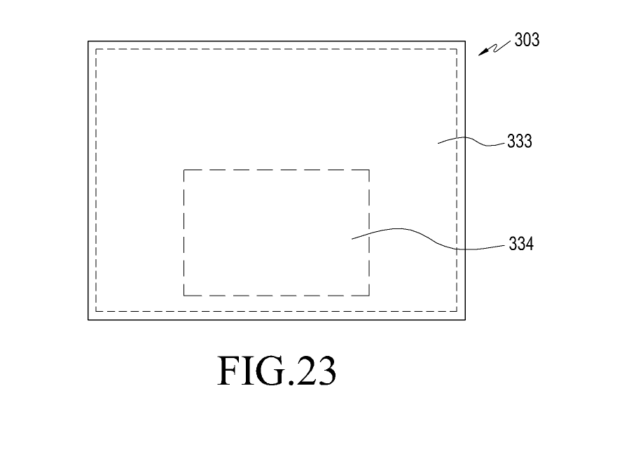

FIG. 23 is a front view illustrating an example ground of an example electronic device.

Referring to FIG. 23, according to an example of the disclosure, the electronic device may include a touch pad 303 and a ground. In the present example, detailed descriptions on the components similar to those of the above-described embodiments will be omitted and the following description will be concentrated on the ground.

The ground 333 may have a size corresponding to the entire size of the touch pad 303. Such a ground 333 may induce a change in reference capacitance of the touch pad 303 by the user's touch.

In addition, according to various examples of the disclosure, the ground 334 may have a size corresponding to that of a part of the touch pad 303. Such a ground 334 may increase the reference capacitance of the touch pad 303 as compared to the ground 333 having a size corresponding to the entire size of the touch pad 303.

As described above, according to various examples of the disclosure, an electronic device may include: a body; a touch pad coupled to the body; a dome switch disposed on a rear surface of the touch pad; and a pressure sensor capable of being in contact with the dome switch. The pressure sensor may detect a pressure applied to the touch pad.

In addition, according to various examples of the disclosure, the dome switch may be positioned between the touch pad and the pressure sensor to deliver the pressure applied to the touch pad to the pressure sensor.

In addition, according to various examples of the disclosure, the pressure sensor may be positioned between the touch pad and the dome switch.

In addition, according to various examples of the disclosure, the electronic device may further include: a circuit board provided on the touch pad; and an integrated circuit chip mounted on the circuit board so as to process a touch position on the touch pad and a first pressure value.

In addition, according to various examples of the disclosure, the electronic device may further include a hinge unit that pivotally couples one end of the body and one end of the touch pad together. Another end of the touch pad may be moved by a pressure applied to the touch pad.

In addition, according to various examples of the disclosure, the pressure sensor may be disposed adjacent to the another end of the touch pad.

In addition, according to various examples of the disclosure, an input method of an electronic device is provided. The input method may include: detecting a touch position of a touch input that is input on the touch pad; detecting a first pressure value applied to the detected touch position; determining the first pressure value as a second pressure value depending on the touch position; and generating an input signal from the touch position and the second pressure value.

In addition, according to various examples of the disclosure, the input method of an electronic device may further include: converting the measured first pressure value into digital value.

In addition, according to various examples of the disclosure, the input method of an electronic device may further include: delivering the touch position and the second pressure value compensated for depending on the touch position to a central processing unit.

In addition, according to various examples of the disclosure, the input method of an input device may further include: comparing the second pressure value with a pre-set third pressure value when a pressure is applied to a region of the touch pad which is adjacent to a portion where the touch pad is pivotally connected with the electronic device; and performing a pre-set input to the electronic device when the second pressure value is larger than the third pressure value.

In addition, according to various examples of the disclosure, an electronic device may include: a touch pad; a pressure sensor positioned below the touch pad; and a controller configured to determines a touch position of a touch input that is input on the touch pad, to determine a first pressure value applied by the touch input as a second pressure value depending on the touch position using the pressure sensor, and to generate an input signal corresponding to the touch position and the second pressure value.

In addition, according to various examples of the disclosure, the electronic device may further include: a display device; and a central processing unit configured to control the electronic device such that, based on the input position and the pressure value of the touch input, an image corresponding to the input position and the pressure value is displayed on the display device.

In addition, according to various examples of the disclosure, an electronic device may include: a touch pad detecting a touch position of a touch input based on a change in capacitance; and a ground disposed to face one surface of the touch pad and to be spaced apart from the touch pad. The touch pad may detect a capacitance value corresponding to the touch input and based on a gap between the touch pad and the ground.

In addition, according to various examples of the disclosure, the touch pad may include: a glass substrate; a first layer disposed on one surface of the glass substrate; and a second layer disposed on one surface of the first layer to transmit an electric signal to the first layer.

In addition, according to various examples of the disclosure, the ground may comprise a metal plate film or a conductive sheet.

In addition, according to various examples of the disclosure, the capacitance may be reduced as compared to a pre-set reference capacitance by a change in electromagnetic field of the touch pad as the gap between the touch pad and the ground is reduced.

While the disclosure has been shown and described with reference to certain examples thereof, it will be understood by those skilled in the art that various changes in form and details may be made therein without departing from the spirit and scope of the disclosure as defined by the appended claims.

What is claimed is:

1. An electronic device comprising:
a body;
a touch pad coupled to the body;
a dome switch disposed on a rear surface of the touch pad; and
a pressure sensor disposed to be in contact with the dome switch,
wherein the pressure sensor detects a pressure applied to the touch pad.

2. The electronic device of claim 1, wherein the dome switch is positioned between the touch pad and the pressure sensor and is configured to deliver the pressure applied to the touch pad to the pressure sensor.

3. The electronic device of claim 1, wherein the pressure sensor is positioned between the touch pad and the dome switch.

4. The electronic device of claim 1, further comprising:
a circuit board provided on the touch pad; and
an integrated circuit chip mounted on the circuit board and configured to process a touch position on the touch pad and a first pressure value.

5. The electronic device of claim 1, further comprising:
a hinge assembly configured to pivotally couple one end of the body and one end of the touch pad together,
wherein another end of the touch pad is moved by a pressure applied to the touch pad.

6. The electronic device of claim 5, wherein the pressure sensor is disposed adjacent to the another end of the touch pad.

7. An input method of an electronic device, comprising:
detecting a touch position of a touch input that is input on the touch pad;
detecting a first pressure value applied to the detected touch position;
determining the first pressure value as a second pressure value based on the touch position; and
generating an input signal from the touch position and the second pressure value.

8. The method of claim 7, further comprising:
converting the measured first pressure value into a digital value.

9. The method of claim 7, further comprising:
providing the touch position and the second pressure value to a central processing unit.

10. The method of claim 7, further comprising:
comparing the second pressure value with a pre-set third pressure value when a pressure is applied to a region of the touch pad which is adjacent to a portion where the touch pad is pivotally connected with the electronic device; and
performing a pre-set input to the electronic device when the second pressure value is larger than the third pressure value.

11. An electronic device comprising:
a touch pad;
a pressure sensor positioned below the touch pad; and
a controller configured to determine a touch position of a touch input that is input on the touch pad, to determine a first pressure value applied by the touch input as a second pressure value based on the touch position using the pressure sensor, and to generate an input signal corresponding to the touch position and the second pressure value.

12. The electronic device of claim 11, further comprising:
a display device; and
a central processing unit configured to control the electronic device to provide an image corresponding to the input position and the pressure value and to display the image on the display device, based on the input position and the pressure value of the touch input.

13. An electronic device comprising:
a touch pad configured to detect a touch position of a touch input based on a change in capacitance; and
a ground disposed to face one surface of the touch pad and to be spaced apart from the touch pad,
wherein the touch pad is configured to detect a capacitance value corresponding to the touch input and based on a gap between the touch pad and the ground.

14. The electronic device of claim 13, wherein the touch pad includes:
a glass substrate;
a first layer disposed on one surface of the glass substrate; and
a second layer disposed on one surface of the first layer, the second layer configured to transmit an electric signal to the first layer.

15. The electronic device of claim 13, wherein the ground comprises at least one of: a metal plate film and a conductive sheet.

16. The electronic device of claim 13, wherein the capacitance value is reduced as compared to a pre-set reference capacitance based on a change in electromagnetic field of the touch pad as the gap between the touch pad and the ground is reduced.
